(19) United States
(12) Patent Application Publication
(10) Pub. No.: US 2013/0073340 A1
(43) Pub. Date: Mar. 21, 2013

(54) SYSTEMS AND METHODS FOR GENERATING BUSINESS INSIGHTS

(71) Applicants: Joakim Alex, Freeport, NY (US); David Bonalle, New Rochelle, NY (US); Nadine Davey-Rogers, Plantation, FL (US); Asaf Zentler, New York, NY (US)

(72) Inventors: Joakim Alex, Freeport, NY (US); David Bonalle, New Rochelle, NY (US); Nadine Davey-Rogers, Plantation, FL (US); Asaf Zentler, New York, NY (US)

(73) Assignee: American Express Travel Related Services Company, Inc., New York, NY (US)

(21) Appl. No.: 13/237,702

(22) Filed: Sep. 20, 2011

(51) Int. Cl. G06Q 10/00

(52) U.S. Cl. 705/7.33; 705/7.29

(57) ABSTRACT

A system for generating business insights is disclosed. The method may comprise analyzing internal data based upon a merchant request, generating a business insight based upon the analysis of the internal data and the merchant request, wherein the business insight is in a category of at least one of: customer intelligence, competitive intelligence, and market intelligence, and transmitting the business insight to a merchant associated with the merchant request. Customer intelligence may comprise information about a customer's spending behavior, demographics, and lifestyle characteristics. Likewise, competitive intelligence may comprise information about the competitive performance of the merchant, customer loyalty trends associated with the merchant, and market share of the merchant, and market intelligence may comprise market demographics, growth drivers, and industry-wide trends. Internal data may comprise data a credit issuer possesses pertaining to a particular consumer.

### FIELD

The present disclosure generally relates to systems and methods for generating business insights.

### BACKGROUND

In the past, merchants have been unable to gain access to an abundance of information associated with their customers. For example, while merchants have attempted to track and analyze information about their customers (e.g., spending behavior, demographics, lifestyle characteristics, etc.), they have been relatively hobbled in their attempts to do so, as for the most part, they are not privy to this type of information (e.g., in order to obtain demographic information about a customer, it has typically been necessary to request it through a customer satisfaction survey, etc.) As such, merchants have suffered with a dearth of competitive intelligence. That is, merchants have been unable to assess their performance in comparison to the performance of their competitors, in terms of customer loyalty trends and market share. Further still, merchants have been limited, if not altogether unsuccessful, in their attempts to gain insight into the market(s) in which they advertise and sell merchandise. For example, merchants have not enjoyed access to market demographics (as opposed to customer demographics), growth drivers, and industry-wide trends.

Thus, what is needed is a system which gives merchants access to a variety of specific information about the growth and performance of their businesses. For example, a system is needed which provides information about customer spending behaviors, lifestyle characteristics, and demographics. Further, a system is needed which provides competitive intelligence, as well as a system which provides market intelligence.

### SUMMARY

The present disclosure includes a system, method, and article of manufacture for generating business insights. The method may comprise analyzing internal data based upon a merchant request, generating a business insight based upon the internal data and the merchant request, while in a category of at least one of: customer intelligence, competitive intelligence, and market intelligence, and transmitting the business insight to a merchant associated with the merchant request. Customer intelligence may comprise information about a customer's spending behavior, demographics, and lifestyle characteristics. Likewise, competitive intelligence may comprise information about the competitive performance of the merchant, customer loyalty trends associated with the merchant, and market share of the merchant, and market intelligence may comprise market demographics, growth drivers, and industry-wide trends. Internal data may comprise data a credit issuer possesses pertaining to a particular consumer.

The method may further comprise generating the business insight based upon differing sets of internal data depending upon the category of the business insight, and dividing the business insight into a transactions metric and a spend metric. A transactions metric may comprise a number of times a customer has utilized a transaction account, and a spend metric may comprise an amount of money spent by a customer during a particular period of time.

The method may further comprise transmitting the business insight to the merchant in a map format. Further still, the method may comprise receiving a service establishment identifier, and generating the business insight based upon the service establishment identifier and for the service establishment associated with the service establishment identifier.

### BRIEF DESCRIPTION OF THE DRAWINGS

The features and advantages of the present disclosure will become more apparent from the detailed description set forth below when taken in conjunction with the drawings. The left-most digit of a reference number identifies the drawing in which the reference number first appears.

FIG. 1 shows an exemplary system diagram in accordance with an embodiment.

FIG. 2 shows a flowchart depicting an exemplary process for generating business insights.

FIG. 3 shows an exemplary business insights interface.

FIG. 4 shows an exemplary customer intelligence interface operating in an overview perspective.

FIG. 5 shows an exemplary customer intelligence interface operating in an overview perspective and permitting selection of a service establishment.

FIG. 6 shows an exemplary customer intelligence interface operating in an overview perspective and displaying a map.

FIG. 7 shows an exemplary customer intelligence interface displaying a detailed map.

FIG. 8 shows an exemplary customer intelligence interface operating in a transaction activity perspective.

FIG. 9 shows an exemplary customer intelligence interface operating in a transaction activity perspective and displaying detailed data for returning and new customers.

FIG. 10 shows an exemplary customer intelligence interface operating in a transaction activity perspective and displaying a variety of sub-options.

FIG. 11 shows an exemplary customer intelligence interface operating in a pivot table perspective.

### DETAILED DESCRIPTION

The detailed description of exemplary embodiments herein makes reference to the accompanying drawings, which show the exemplary embodiments by way of illustration and their best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In one exemplary embodiment, a system, method and/or computer program product for generating business insights is disclosed. As used herein, business insights may include customer intelligence, competitive intelligence, and/or market intelligence. Customer intelligence may include information about a customer's spending behavior, demographics, lifestyle characteristics, and/or the like. Competitive intelligence may include information about a merchant's competitors and/or the merchant's relationship to competitors, including information about the merchant's competitive performance, customer loyalty trends, market share, and/or the like. Market intelligence may include information about a particular market, including market demographics, growth drivers, industry-wide trends, and/or the like.

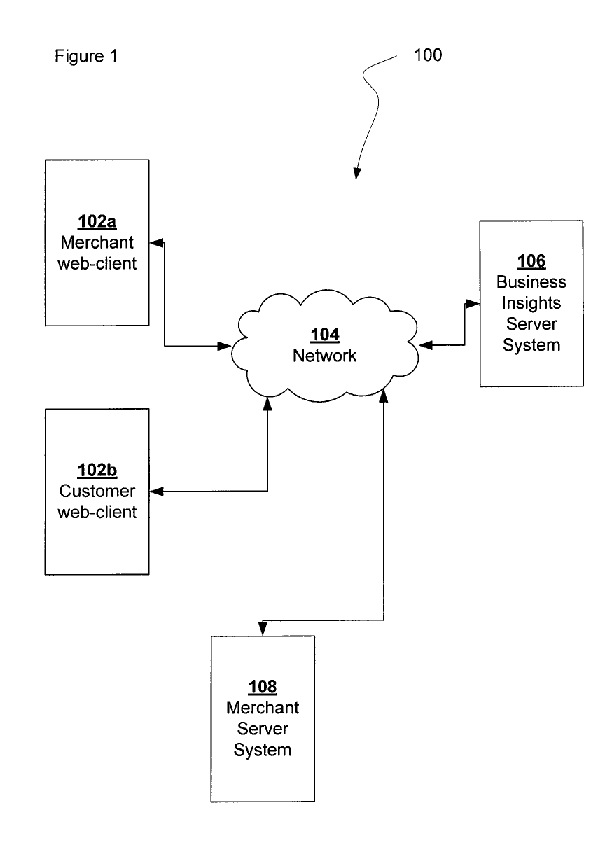

Referring to FIG. 1, an exemplary system 100 for generating business insights may comprise a merchant web-client 102a, a customer web-client 102b, a network 104, a business insights server system 106, and/or a merchant server system 108.

Web-client 102a and/or 102b may include any software and/or hardware (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client 102a and/or 102b may run Microsoft Internet Explorer, Mozilla Firefox, Google Chrome, Apple Safari, or any other of the myriad software packages available for browsing the internet.

Practitioners will appreciate that web client 102a and/or 102b may or may not be in direct contact with an application server. For example, web client 102a and/or 102b may access the services of an application server through another server and/or hardware component, which may have a direct or indirect connection to an Internet server. For example, web client 102a and/or 102b may communicate with an application server via a load balancer. In an exemplary embodiment, access is through a network or the Internet through a commercially-available web-browser software package.

As those skilled in the art will appreciate, web client 102a and/or 102b includes an operating system (e.g., Windows NT, 95/98/2000/CE/Mobile, OS2, UNIX, Linux, Solaris, MacOS, PalmOS, etc.) as well as various conventional support software and drivers typically associated with computers. Web client 102a and/or 102b may include any suitable personal computer, network computer, workstation, personal digital assistant, cellular phone, smart phone, minicomputer, mainframe or the like. Web client 102a and/or 102b can be in a home or business environment with access to a network. In an exemplary embodiment, access is through a network or the Internet through a commercially available web-browser software package. Web client 102a and/or 102b may implement security protocols such as Secure Sockets Layer (SSL) and Transport Layer Security (TLS). Web client 102a and/or 102b may implement several application layer protocols including http, https, ftp, and sftp.

As used herein, a network 104 includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network 104 is in the nature of a public network, such as the Internet, it may be advantageous to presume the network 104 to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network 104 via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network 104 may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

A business insights server system (“BISS”) 106 may comprise any type of hardware and/or software (e.g., a computer server) configured or configurable to generate and/or receive/process business insights. Typically, such a server comprises a server appliance (e.g., a rack mountable server appliance) running a suitable server application (e.g., IIS).

A merchant server system (“MSS”) 108 may comprise any type of hardware and/or software (e.g., a computer server) configured or configurable to generate and/or display a merchant website (e.g., electronic commerce website). Typically, such a server comprises a server appliance (e.g., a rack mountable server appliance) running a suitable server application (e.g., IIS).

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

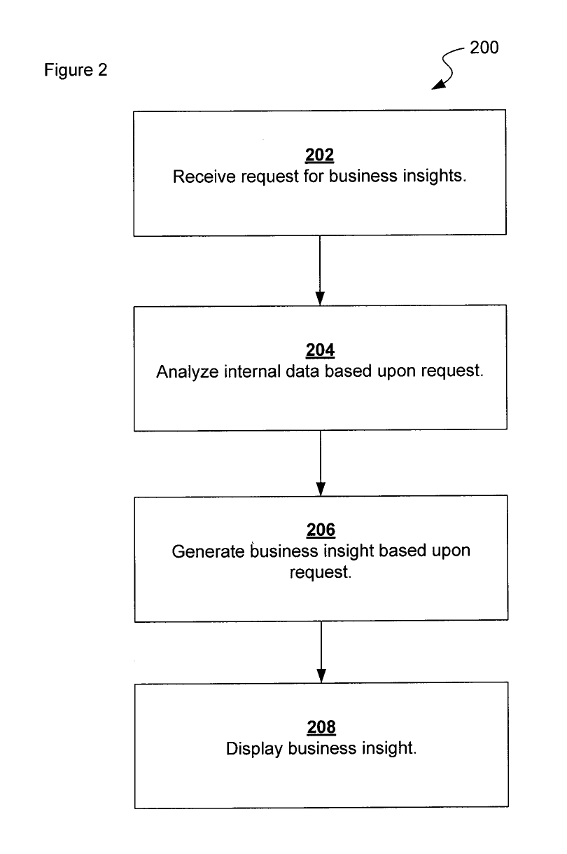

Referring now to FIGS. 2-11 the process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-11, but also to the various system components as described above with reference to FIG. 1.

With reference to FIG. 2, a process 200 for providing business insights may include a request, by a merchant, for business insights (step 202). More particularly, a merchant may request business insights using, for example, merchant web-client 102a. In response to the request, business insights server system 106 may analyze a variety of “internal data” (step 204). The analysis performed by BISS 106 may depend on the particular merchant request. For example, where a merchant requests customer intelligence, BISS 106 may analyze a first set of internal data. Likewise, where a merchant requests competitive intelligence, BISS 106 may analyze a second set of internal data, and where a merchant requests market intelligence, BISS 106 may analyze a third set of internal data. Any of the first, second, and third sets of internal data may, in an embodiment, at least partially overlap, comprise identical data sets, and/or comprise distinct data sets. Furthermore, BISS 106 may analyze internal data to generate statistics, summaries, averages, trends, and/or other mathematical results, and may contribute to the particular business insight requested by the merchant.

Internal data may be collected or otherwise stored for an individual who has conducted a transaction online or at a brick and mortar merchant location. Where internal data is associated with an online transaction, it may be received from customer web-client 102b and/or MSS 108 and by BISS 106. In other words, a customer who conducts a web-based transaction with a merchant may supply certain data to MSS 108 and/or, directly or indirectly (e.g., through a payment processing system, gateway, and/or another intermediary system) to BISS 106.

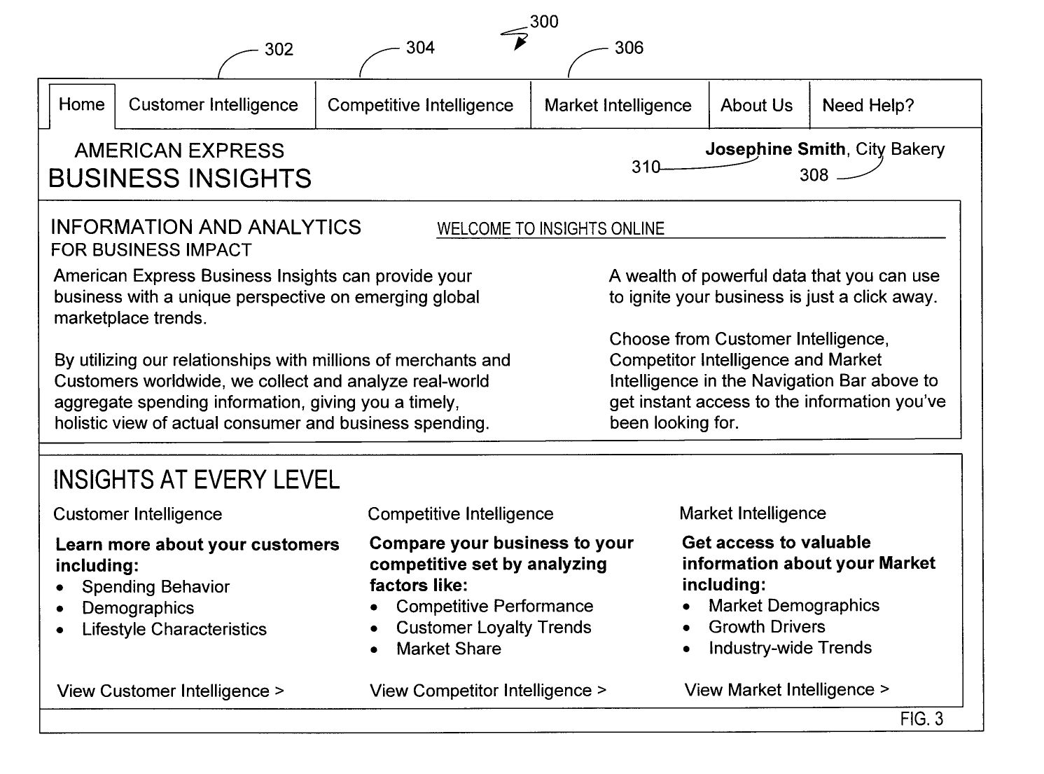

BISS 106 may further generate reports and/or display results related to the request for business insights (step 206). The reports and/or results may be displayed by merchant web-client 102a (step 208). That is, a merchant may receive, review and/or interact with business insights via a web-based system, as described below with reference to FIGS. 3-11.

In an embodiment, BISS 106 may generate business insights in three primary categories. As provided above, these categories may include: customer intelligence, competitive intelligence, and market intelligence. Each category may be further divided or organized based upon two basic metrics. These sub-categories may include: transactions and spend. Transaction metrics are those metrics related, in general, to a number of times a customer has utilized a transaction account. Spend metrics, on the other hand, are those metrics related, in general, to an amount of money spent during a particular period of time.

With reference to FIG. 3, an exemplary business insights interface 300 may permit a merchant to select from a variety of options, including an option to receive customer intelligence 302, an option to receive competitive intelligence 304, and/or an option to receive market intelligence 306. In an embodiment, the interface 300 may be displayed after a merchant has logged in or identified himself to BISS 106. For example, in FIG. 3, the interface 300 is displayed for the merchant City Bakery 308. More particularly, the interface 300 is displayed for Josephine Smith 310, an individual associated (e.g., an employee, owner, etc.) with the merchant City Bakery 308.

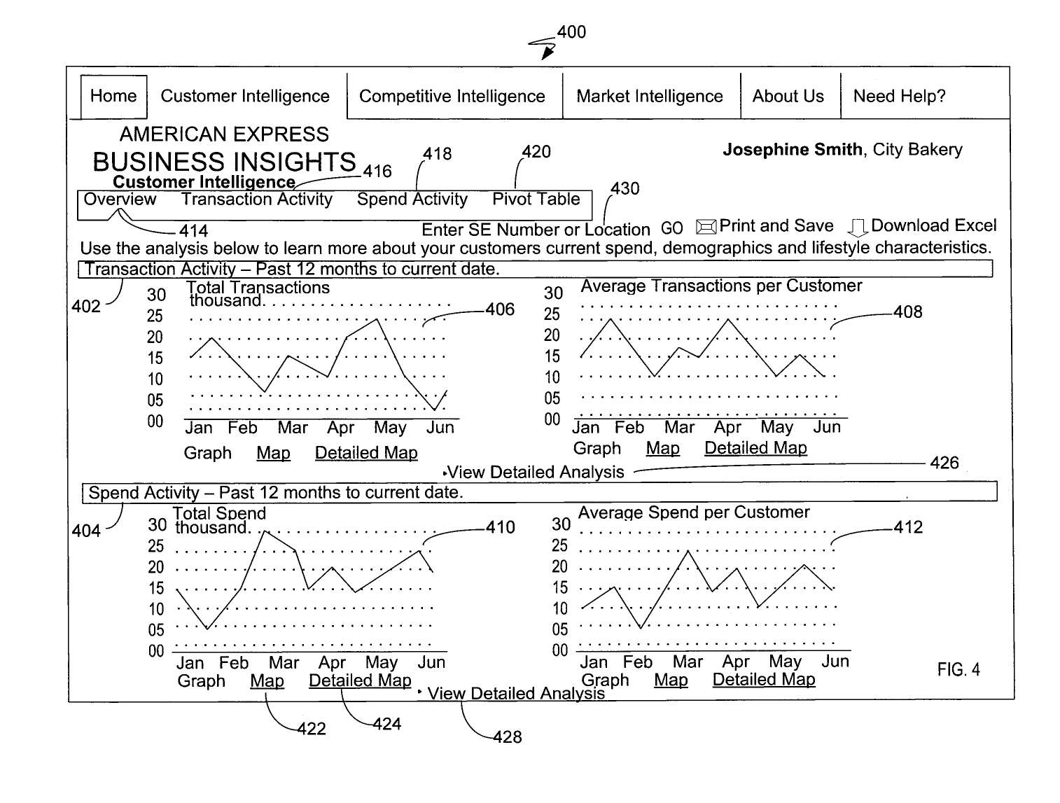

With reference now to FIG. 4, a customer intelligence interface 400 may provide insight into the current spending, demographics, and/or lifestyle characteristics of a merchant's customers. Further, interface 400 may permit a merchant to review customer intelligence from a variety of perspectives. For instance, interface 400 may permit a merchant to review an Overview 414 of customer intelligence (as depicted), or interface 400 may permit a merchant to limit his results to Transaction Activity 416, Spend Activity 418, or a Pivot Table 420.

Further still, where the Overview 414 perspective is selected, customer intelligence interface 400 may display results under two metric headings: transaction activity 402 and/or spend activity 404. A variety of charts/graphs/etc. may be displayed under each metric heading, including, a total transactions graph 406, an average transactions graph 408, a total spend graph 410, and/or an average spend per customer graph 412. Each chart and/or graph may be encompass a particular time period (e.g., 1 day, 1 week, 2, 2 weeks, 1 month, 2 months, 3, months, 6, months, 12, months, etc.), depending upon a merchant's preference. That is, a merchant may specify a time period in which to review a business insight.

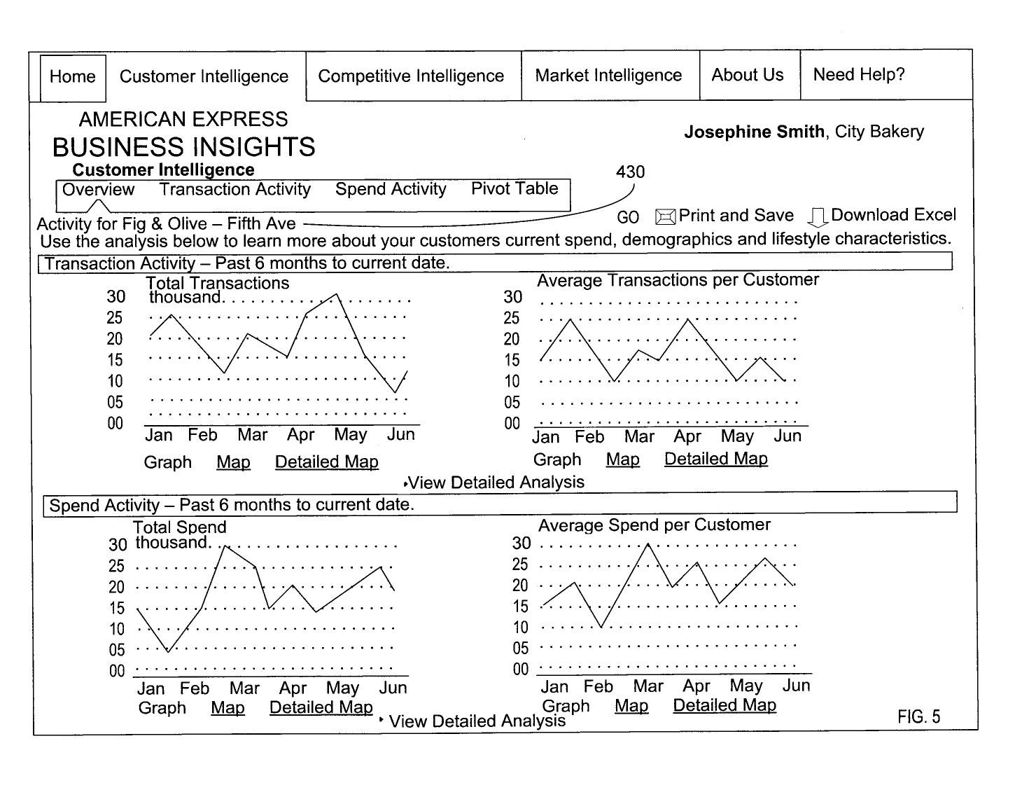

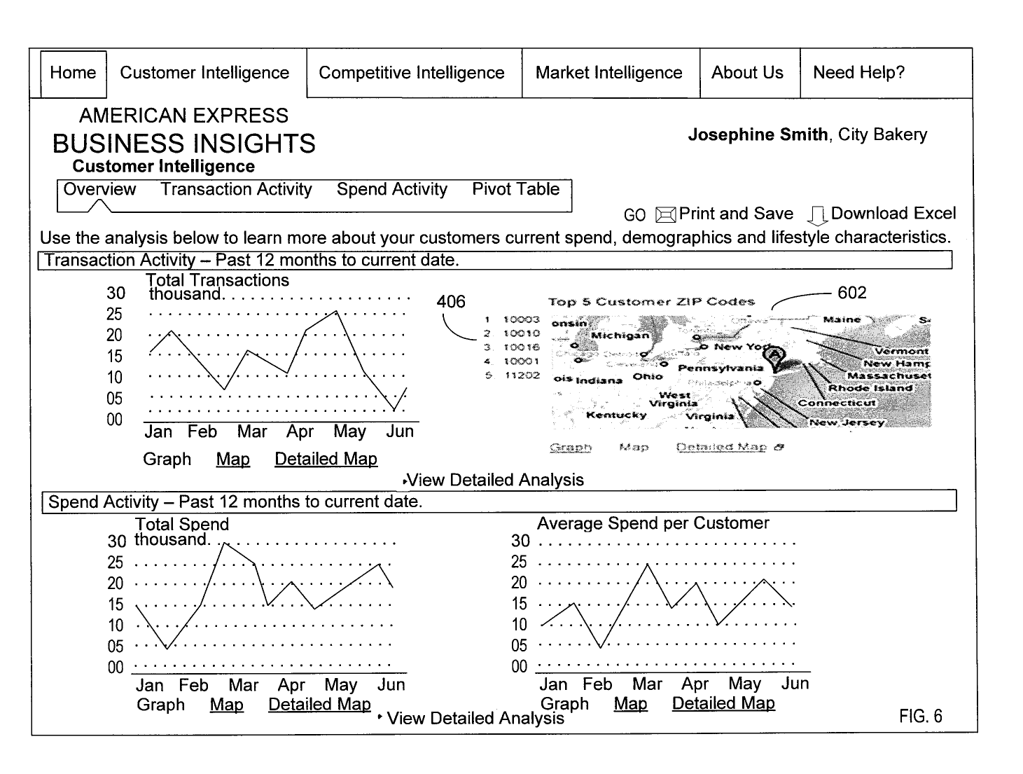

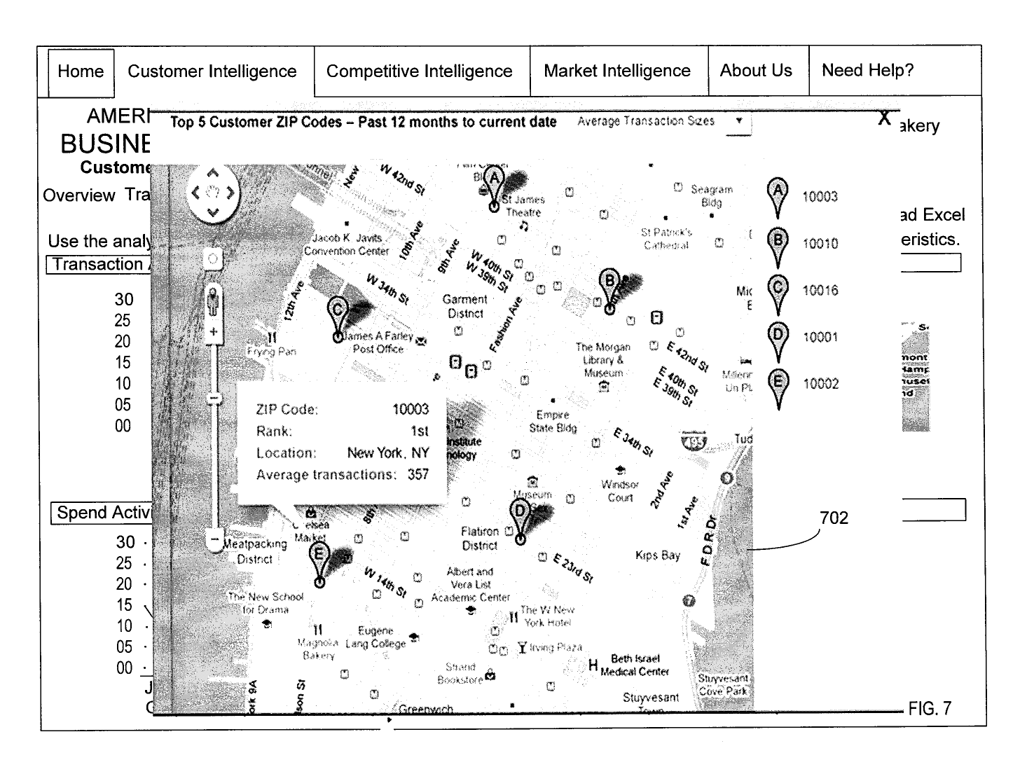

Continuing, in an embodiment, there may be presented an option to view a map 422 and/or an option to view a detailed map 424. These options may be associated with any report/graph/chart (including charts 406, 408, 410, and/or 412) as well as presented under any metric heading 402 and/or 404. In addition, there may be presented, under each metric heading 402 and/or 404, an option to View Detailed Analysis 426 and/or 428. These options 426 and/or 428 may permit a merchant to view detailed information/analyses about transaction activity and/or spend activity, respectively. Furthermore, an option may be presented to enter a service establishment (“SE”) or location 430 associated with the merchant (City Bakery, in this example).

Where a merchant selects an SE/location 430, customer intelligence interface 400 may display information associated with the particular SE/location. This is depicted at FIG. 5, where, for example, the merchant City Bakery has selected the merchant location Fig & Olive-Fifth Ave from three SEs/locations: Fig & Olive-Fifth Ave, Fig & Olive-Meatpacking, and Fig & Olive-Uptown (not shown).

Where a merchant selects a Map option 422, a map 602 showing a highest ranked (e.g., by total transactions, average transactions, total spend activity, average spend activity) merchant location or group of merchant locations may be displayed. This is illustrated at FIG. 6, where a map 602 showing the top 5 customer zip codes (according to an average number of transactions) is displayed. To the left of the map 602, a list 604 of the top 5 customer zip codes may appear. A merchant may specify the number of results (e.g., top customer zip codes) that should be included in a map 602 and/or a greater or lesser number of results than 5 may be displayed by default. Where a merchant selects a Detailed Map option 424, and with reference to FIG. 7, a larger, more detailed map 702 may be displayed. Detailed map 702 may be displayed as a pop out, as part of the open interface 400, or as part of a new window and/or interface (not shown). As described above with reference to the map 602, a detailed map 702 may display a highest ranked merchant location or merchant locations. Map 602 and/or detailed map 702 may comprise one or more maps generated by one or more application programming interfaces (“APIs”). For example, in various embodiments, map 602 and/or detailed map 702 may be generated by Google® Maps and/or may be generated by Google® Analytics according to information provided by BISS 106.

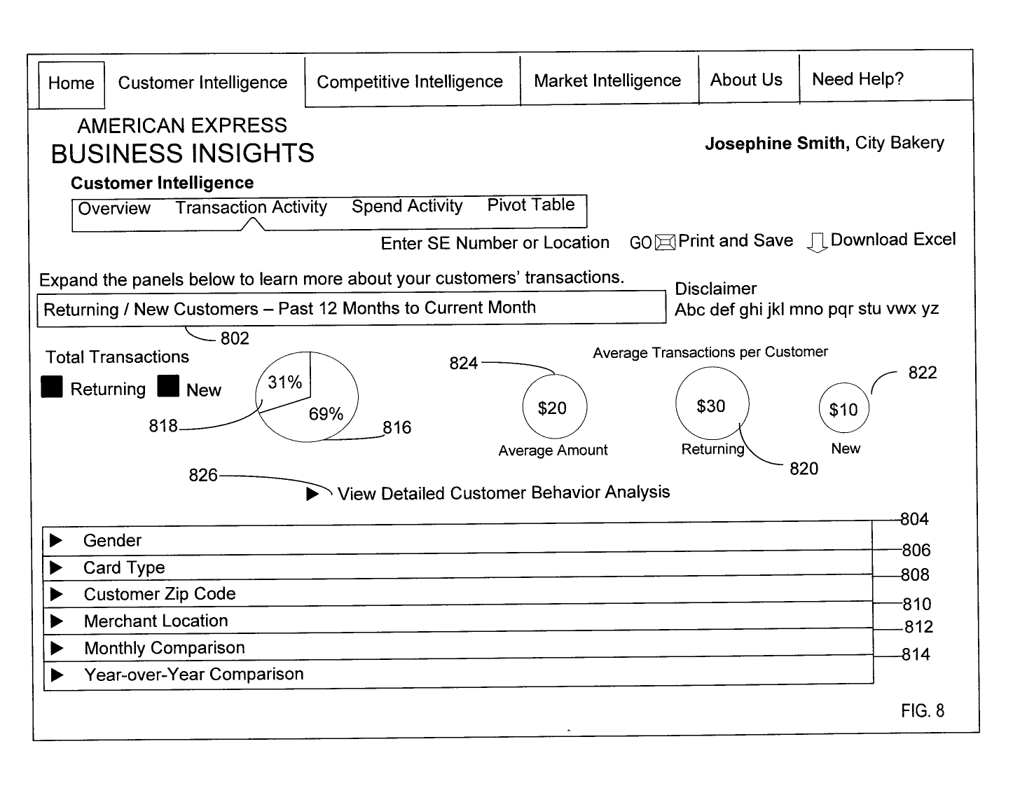

With reference now to FIG. 8, customer intelligence interface 400 is shown with the Transaction Activity perspective 416 selected. With respect to FIG. 8, although the Transaction Activity perspective 416 is illustrated, the following description applies equally to the Spend Activity perspective 418, where the only difference between the two perspectives comprises the data on which results are based. That is, results in perspective 416 are based upon transaction data, while results in perspective 418 are based upon spend data.

Accordingly, from either perspective 416 and/or 418, a variety of sub-options may be presented. Each sub-option may permit a merchant to review customer intelligence in a different light and/or according to a different parameter and/or set of parameters. For example, interface 400 may include the following sub-options: Returning/New Customers 802, Gender 804, Card Type 806, Customer Zip Code 808, Merchant Location 810, Monthly Comparison 812, and/or Year-over-Year Comparison 814.

A Returning/New Customers sub-option 802 may permit a merchant to review a percentage of sales (again, based upon spend data and/or transaction data) to returning and/or new customers. Thus, in the example provided at FIG. 8, a percentage of returning customers 816 may be displayed together with a percentage of new customers 818, and these percentages may be displayed in a pie chart, bar chart, and/or any other of the myriad graphical/numerical modes of representation which may be available. Further, an average dollar amount may be associated with new and returning customers and displayed in association with (or apart from) the percentages of new and returning customers 816 and 818. For example, the internal data may be analyzed by BISS 106 to show that returning customers spend a certain amount per transaction 820 (e.g., 30 dollars), and that new customers spend a certain amount per transaction 822 (e.g., 10 dollars), which may be the same or different from the amount that returning customers spend. An average spending amount 824 for new and returning customers may also be displayed.

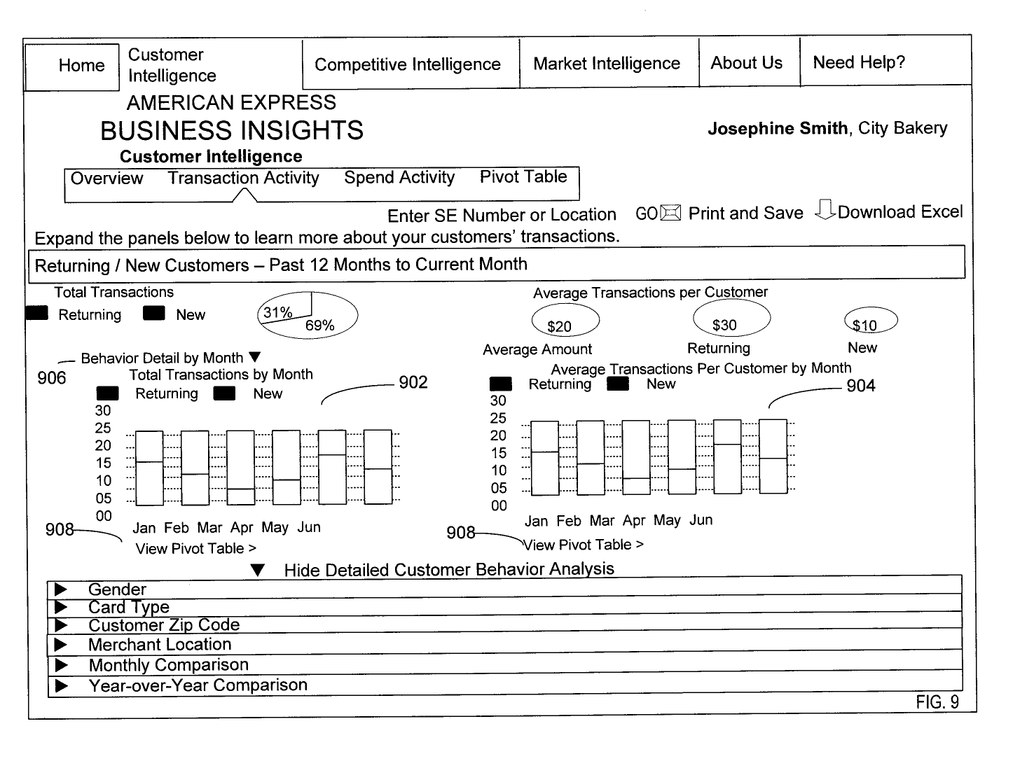

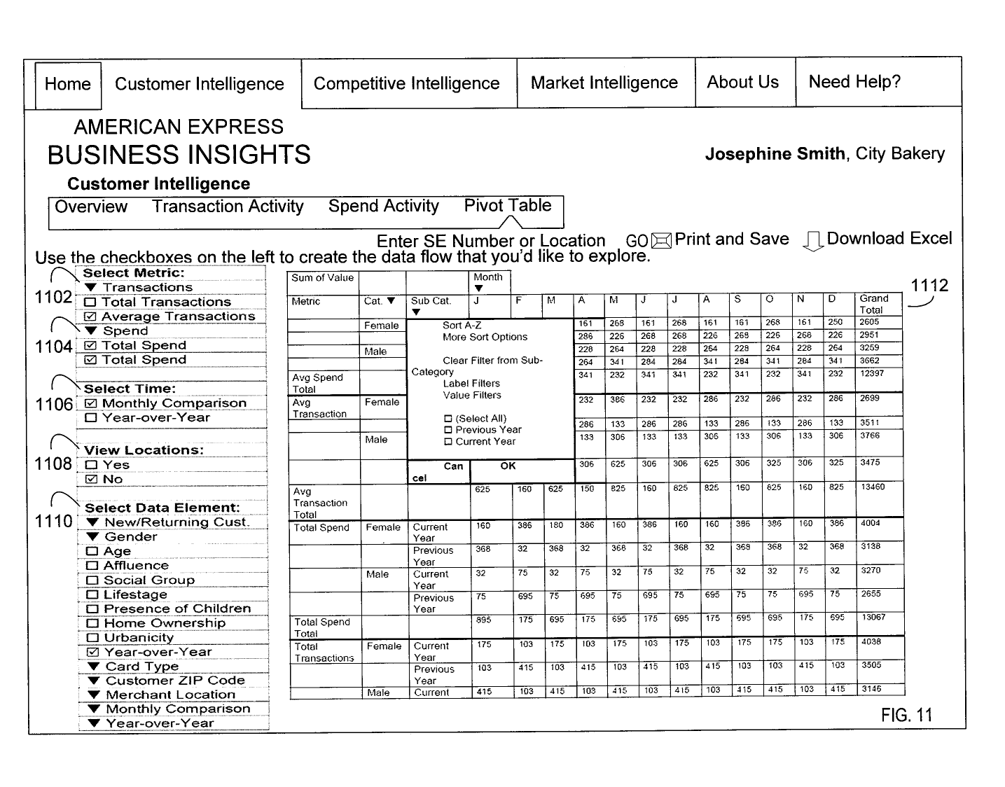

With continuing reference to FIG. 8, an option to View Detailed Customer Behavior Analysis 826 may be presented. An exemplary detailed customer behavior analysis is illustrated at FIG. 9. The analysis may display a total number of transactions 902 and an average number of transactions 904 for returning and new customers. Each of the total number of transactions 902 and the average number of transactions 904 may be organized in a time period or time periods 906 (e.g., days, months, weeks, years), and these may be selected by the merchant. Each analysis 902 and 904 may include an option 908 to View Pivot Table. The Pivot Table perspective 420 is described below with reference to FIG. 11.

With respect to Gender sub-option 804, this option may permit a merchant to review customer intelligence based on the gender associated with its customers. For example, Gender sub-option 804 may permit a merchant to review a percentage/number of total/average transactions associated with male and female customers.

With respect to Card Type sub-option 806, this option may permit a merchant to review customer intelligence based on one or more card types (e.g., Consumer, Small Business, Corporate, etc.) associated with its customers. For example, Card Type sub-option 806 may permit a merchant to review a percentage/number of total/average transactions associated with customers having one or more card types.

With respect to Customer Zip Code sub-option 808, this option may permit a merchant to review customer intelligence based on the zip codes associated with its customers. For example, Customer Zip Code sub-option 808 may permit a merchant to review a percentage/number of total/average transactions associated with customers in one or more zip codes.

With respect to Merchant Location sub-option 810, this option may permit a merchant to review customer intelligence based on merchant locations from which its customers made purchases. For example, Merchant Location sub-option 810 may permit a merchant to review a percentage/number of total/average transactions made by customers from one or more merchant locations.

With respect to Monthly Comparison sub-option 812, this option may permit a merchant to review a comparison of customer intelligence between one or more months of sales to customers. For example, Monthly Comparison sub-option 812 may permit a merchant to review a percentage/number of total/average transactions made by customers during one or more months.

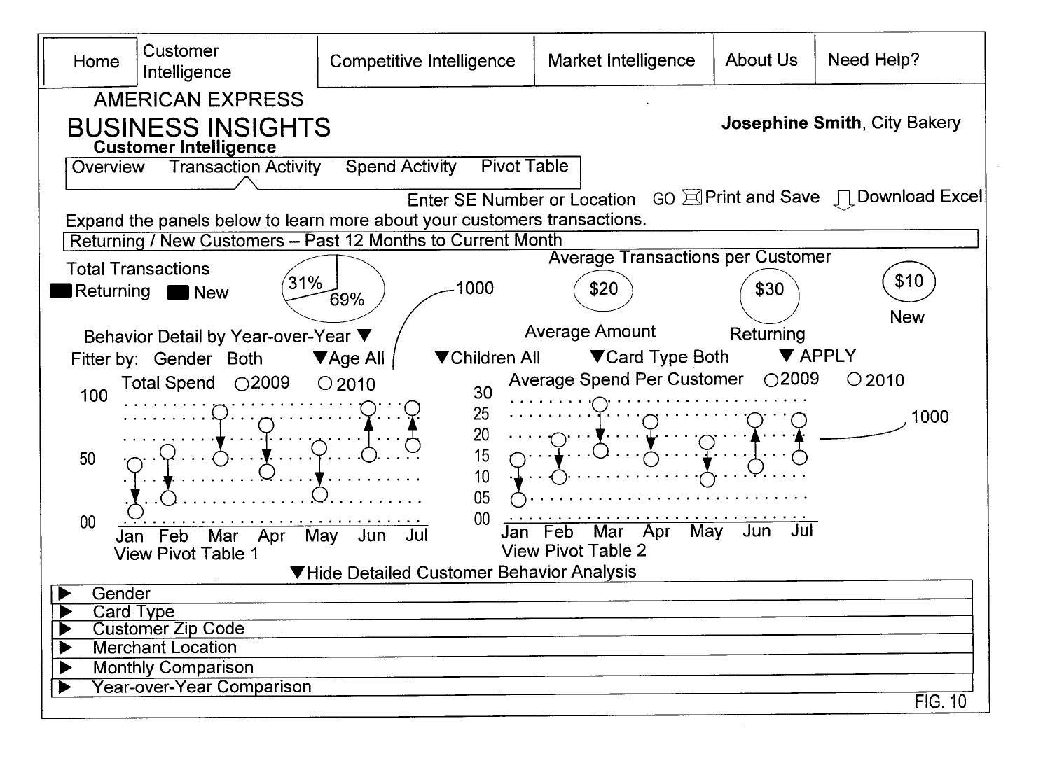

With respect to Year-over-Year Comparison sub-option 814, this option may permit a merchant to review a comparison of customer intelligence between one or more years of sales to customers. For example, Year-over-Year Comparison sub-option 814 may permit a merchant to review a percentage/number of total/average transactions made by customers during one or more years. In an embodiment, sub-option 814 may permit a merchant to review a change between a first year and a second year 1000, and this change may be presented in monthly increments. As above, change may be measured with respect to total and/or average transactions/spend. This is illustrated at FIG. 10.

With reference now to FIG. 11, customer intelligence interface 400 is shown with the Pivot Table perspective 420 selected. As described above with reference to the other perspectives, 414-418, data displayed in the Pivot Table perspective 420 may be based upon metrics such as total and/or average transaction data 1102 and/or total and/or average spend data 1104, and a merchant may make a selection from these as desired. A merchant may further have an option to select a time 1106 (e.g., a monthly comparison, year-over-year, etc.), a location 1108, and a data element 1110. As discussed above, a location may comprise one or more merchant locations. Likewise, a data element may, as discussed above, comprise a new/returning customer element, a gender element, a card type element, a customer zip code element, a merchant location element, a monthly comparison element, and a year-over-year element. Each data element may further comprise one or more sub-elements, such as, for example, age, affluence, social group, lifestage, presence of children, home ownership, urbanicity and year-over-year. Each of these data elements and sub-elements may be selected by a merchant.

In response to selection of one or more of the metrics 1102, 1104, spend 1104, time 1106, location 1108, and/or data elements/sub-elements 1110, BISS 106 may generate a pivot table 1112, which may display data in a tabular format according to the parameters selected by the merchant.

Thus, a merchant may manipulate a variety of parameters/variables/data to generate a large variety of reports and business insights. These reports/business insights may be used by a merchant to assess a large variety of factors affecting their sales, ranging from poor sales at a particular location to improved sales over a particular year and/or to a particular demographic, and beyond. Further, the data with which BISS 106 may generate the reports/results for a merchant are quite unique, as discussed above, in that they are primarily/largely unavailable to merchants and/or other third party data providers. In other words, BISS 106 provides a diverse and powerful range of business insights based on its unique access to a large variety of internal data—i.e., data about transaction account customers that is only available, in the aggregate and in consolidated detail, to a transaction account issuer (e.g., American Express).

Further, although not every report and option available under the customer intelligence interface 400 has been discussed in exhaustive detail, practitioners will appreciate that a variety of reports and data processing are within the scope of the present disclosure. Moreover, although each and every report available under the competitive intelligence and market intelligence interfaces has not been described in detail, practitioners will appreciate that the internal data relied upon to generate the reports and interfaces described with respect to the customer intelligence interface may serve as a basis for similar, if not identical, reports and interfaces in the competitive intelligence and market intelligence interfaces. For example, the competitive intelligence and market intelligence interfaces, like the customer intelligence interface, may display data in a map format.

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers. A user may include any individual, business, entity, government organization, software and/or hardware that interact with a system.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable.

Phrases and terms similar to an “item” may include any good, service, information, experience, data, content, access, rental, lease, contribution, account, credit, debit, benefit, right, reward, points, coupons, credits, monetary equivalent, anything of value, something of minimal or no value, monetary value, non-monetary value and/or the like.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, and symmetric and asymmetric cryptosystems.

The computing unit of the web client may be further equipped with an Internet browser connected to the Internet or an intranet using standard dial-up, cable, DSL or any other Internet protocol known in the art. Transactions originating at web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, machine, hardware, software or business. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like. 100861 The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

In yet another embodiment, the transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts or devices, a transponder and reader in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases similar to a “payment processor” may include a company (e.g., a third party) appointed (e.g., by a merchant) to handle transactions for merchant banks. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method comprising:
analyzing, by a computer-based system for generating business insights, internal data based upon a merchant request;
generating, by the computer-based system, a business insight based upon the analysis of the internal data and the merchant request, wherein the business insight is in a category of customer intelligence, and wherein the business insight comprises at least one of: information about a total number of transactions by customers of the merchant with the merchant, information about an average number of transactions by the customers of the merchant with the merchant information about the spending by the customers of the merchant with the merchant, and information about an average spending by the customers of the merchant with the merchant; and
transmitting, by the computer-based system, the business insight to a merchant associated with the merchant request.

2. The method of claim 1, wherein customer intelligence comprises information about a spending behavior associated with a customer, demographics associated with the customer, and lifestyle characteristics associated with the customer.

3. The method of claim 2, wherein the business insight is in a category of competitive intelligence, and wherein competitive intelligence comprises information about the competitive intelligence, and wherein competitive intelligence comprises information about the competitive performance of the merchant, customer loyalty trends associated with the merchant, and market share of the merchant.

4. The method of claim 3, wherein the business insight is in a category of market intelligence, and wherein market intelligence comprises market demographics, growth drivers, and industry-wide trends.

5. The method of claim 1, wherein the internal data comprises data a credit issuer possesses pertaining to a particular consumer.

6. The method of claim 1, further comprising generating, by the computer-based system, the business insight based upon differing sets of internal data depending upon the category of the business insight.

7. The method of claim 1, further comprising dividing, by the computer-based system, the business insight into a transactions metric and a spend metric.

8. The method of claim 7, wherein the transactions metric comprises a number of times a customer has utilized a transaction account, and a spend metric comprises an amount of money spent by a customer during a particular period of time.

9. The method of claim 1, further comprising transmitting, by the computer-based system, the business insight to the merchant in a map format.

10. The method of claim 1, further comprising:
receiving, by the computer-based system, a service establishment identifier; and
generating, by the computer-based system, the business insight based upon the service establishment identifier and for the service establishment associated with the service establishment identifier.

11. An article of manufacture including a non-transitory, tangible computer readable storage medium having instructions stored thereon that, in response to execution by a computer-based system for generating business insights, cause the computer-based system to perform operations comprising:
analyzing, by the computer-based system, internal data based upon a merchant request:
generating, by the computer-based system, a business insight based upon the analysis of the internal data and the merchant request, wherein the business insight is in a category of one of: customer intelligence, and wherein the business insight comprises at least one of: information about a total number of transactions by customers of the merchant with the merchant, information about an average number of transactions by the customers of the merchant with the merchant, information about the spending by the customers of the merchant with the merchant, and information about an average spending by the customers of the merchant with the merchant; and
transmitting, by the computer-based system, the business insight to a merchant associated with the merchant request.

12. The article of claim 11, wherein the business insight is in a category of at least one of: competitive intelligence and market intelligence, and wherein competitive intelligence comprises information about the competitive performance of the merchant, customer loyalty trends associated with the merchant, and market share of the merchant, and wherein market intelligence comprises market demographics, growth drivers, and industry-wide trends.

13. The article of claim 11, further comprising generating, by the computer-based system, the business insight based upon differing sets of internal data depending upon the category of the business insight.

14. The article of claim 11, further comprising dividing, by the computer-based system, the business insight into a transactions metric and a spend metric, wherein the transactions metric comprises a number of times a customer has utilized a transaction account, and a spend metric comprises an amount of money spent by a customer during a particular period of time.

15. The article of claim 11, further comprising transmitting, by the computer-based system, the business insight to the merchant in a map format.

16. The article of claim 11, comprising:
receiving, by the computer-based system, a service establishment identifier; and
generating, by the computer-based system, the business insight based upon the service establishment identifier and for the service establishment associated with the service establishment identifier.

17. A system comprising:
a tangible, non-transitory memory communicating with a processor for generating business insights,
the tangible, non-transitory memory having instructions stored thereon that, in response to execution by the processor, cause the processor to perform operations comprising:
analyzing, by the processor, internal data based upon a merchant request;
generating, by the processor, a business insight based upon the analysis of the internal data and the merchant request, wherein the business insight is in a category of customer intelligence, and wherein the business insight comprises at least one of: information about a total number of transactions by customers of the merchant with the merchant, information about an average number of transactions by the customer of the merchant with the merchant, information about the spending by the customers of the merchant with the merchant, and information about an average spending by the customers of the merchant with the merchant; and
transmitting, by the processor, the business insight to a merchant associated with the merchant request.

18. The system of claim 17, wherein the business insight is in a category of at least one of: competitive intelligence and market intelligence, and wherein competitive intelligence comprises information about the competitive performance of the merchant, customer loyalty trends associated with the merchant, and market share of the merchant, and wherein market intelligence comprises market demographics, growth drivers, and industry-wide trends.

19. The system of claim 17, further comprising dividing, by the processor system, the business insight into a transactions metric and a spend metric, wherein the transactions metric comprises a number of times a customer has utilized a transaction account, and a spend metric comprises an amount of money spent by a customer during a particular period of time.

20. The system of claim 17, further comprising transmitting, by the processor, the business insight to the merchant in a map format.
